(19) United States
(12) Patent Application Publication
(10) Pub. No.: US 2016/0002462 A1
(43) Pub. Date: Jan. 7, 2016

(54) CELLULOSE NANOCRYSTALS - THERMOSET RESIN SYSTEMS, APPLICATIONS THEREOF AND ARTICLES MADE THEREFROM

(71) Applicant: FPINNOVATIONS, Pointe-Claire (CA)

(72) Inventors: Yaolin ZHANG, Quebec (CA); Lamfeddal KOUISNI, St-Leonard (CA); Xiang-Ming WANG, Quebec (CA); Michael PALEOLOGOU, Beaconsfield (CA); Martin W. FENG, Vancouver (CA); Gilles BRUNETTE, Quebec (CA); Guangbo HE, Richmond (CA); Hui WAN, Starkville, MS (US); Ayse ALEMDAR-THOMSON, Vancouver (CA)

(73) Assignee: FPINNOVATIONS, Pointe-Claire (CA)

(21) Appl. No.: 14/768,137

(22) PCT Filed: Feb. 14, 2014
(86) PCT No.: PCT/CA2014/050105

§ 371 Date: Aug. 14, 2015

Related U.S. Application Data
(60) Provisional application No. 61/765,454, filed on Feb. 15, 2013.

(51) Int. Cl. C08L 61/12; C08L 1/02

(52) U.S. Cl. CPC C08L 61/12; C08L 1/02

(57) ABSTRACT

The present describes wood adhesives reinforced with cellulose nanocrystals (CNC), in liquid and powder forms in which resin system are a phenol-formaldehyde polymer and/or lignin-phenol-formaldehyde polymer and polymeric methylene diphenyl diisocyanate (pMDI), and a method of making this polymer in liquid and powder from and the composite products that can be produced therefrom.

### BACKGROUND OF THE INVENTION

1. Field of the Invention

The present invention relates to thermoset resin systems, which include a phenol-formaldehyde polymer and/or lignin-phenol-formaldehyde polymer reinforced with cellulose nanocrystals (CNC), and polymeric MDI reinforced with CNC, a method of making this polymer and the composite products that can be produced therefrom.

2. Description of Related Art

Traditional lignocellulosic composites can be classified into four main groups based on raw material geometries: veneer-based, strand-based, particle-based and fiber-based materials. The veneer-based materials are used to manufacture plywood and laminated veneer lumber (LVL), the strand-based materials for waferboard and oriented strand board (OSB) for exterior applications, the particle-based materials for particleboard (PB), and the fiber-based materials for medium density fiberboard (MDF), high density fiberboard (HDF) and low density fiberboard (LDF).

Wood adhesives are key components for manufacturing wood composite panels. According to the latest forecast by Resource Information Systems Inc. (RISI), total resin consumption in 2009 in North America was 3211 million pounds (1.46 million metric tons) [on a 100% non-volatile solids basis for all resins except for phenol-resorcinol-formaldehyde (PRF) resin on a liquid basis]. Urea-formaldehyde (UF) resin was dominant in resin consumption about 61% of the total consumption used in the manufacture of MDF, HDF and PB, followed by 23% liquid phenol-formaldehyde (PF) resin for HDF, PB, LVL, OSB and softwood plywood panel. The rest 16% includes 3.53% for melamine-formaldehyde (MF) resin in the manufacture of MDF and PB, 5.53% for powder PF in OSB production, 6.65% for polymeric methylene diphenyl diisocyanate (pMDI) resin in the manufacture of MDF, PB and OSB, and 7.41% and 2.94% for PRF resin and emulsion polymer isocyanate (EPI) resin, respectively, in the fabrication of I-Joist. Because of the subsequent release of formaldehyde from wood composites made with UF or MUF adhesives, these adhesives are faced with increasingly more stringent regulations. As phenolic resins have better thermal resistance and weather resistance than amino adhesives, PF resins are commonly used for the manufacture of OSB and exterior grade plywood. They have also been used for particleboard and fiberboard manufacturing. Furthermore, PF resins are known to have very low formaldehyde emissions from their composites products throughout the service life.

Wang, S. Q., C. Xing, Wood adhesives containing reinforced additives for structural engineering products, International Application Number WO 2009/086141 A2, 2009, added cellulose microfiber (MFC) (30 μm×18 μm×1-2 μm) to a commercial phenolic resin (GP 205C) through a mechanical mixer. The PF composites films are made and maintained under vacuum to remove the bubbles and water at 70° C. for few hours. Afterward, the PF composites films are cured with a hot press (160° C. for 4 minutes). Wang and Xing, found that the modulus of elasticity (MOE) increased from 3388 MPa and 4181 MPa with 1% MFC, and modulus of rupture (MOR) increased from 79 MPa to 92 MPa. However, OSB panels made with these phenolic resins with/without MFC did not produce a significant increase of internal bond (IB) strength, MOE and MOR, and reduction of thickness swelling (TS), of OSB panels. The OSB panels made with MUPF (melamine-urea-phenol-formaldehyde) resin that included a combination of nano-clay and MFC improved the IB, MOE and MOR performance.

Liu H., and M. P. G. Laborie (2010) “In situ cure of cellulose whiskers reinforced thermosetting phenolic resins: Impact on resin morphology, cure and performance” Proceedings of the International Convention of Society of Wood Science and Technology and UN Economic Commissions for Europe—Timber Committee, October 11-14, Geneva, Switzerland; and Liu H., and M. P. G. Laborie (2011). “Bio-based nanocomposites by in situ cure of phenolic prepolymers with cellulose whiskers” Cellulose, 18: 619-630, studied nanoscale cellulose whiskers (CNWs) used in a phenolic (PF) resin. The authors investigated the effect of the processing conditions on producing well dispersed nanocomposites, and the impact of CNWs on the cure properties of phenolic resins. Cellulose whiskers were prepared by acid hydrolysis of microcrystalline cellulose. The CNWs were mixed with PF resin at different loadings. To avoid bubble formation during the cure, the dispersion was solvent exchanged to dimethyl formamide. Films of the nanocomposites were prepared by pre-curing of the CNWs-phenolic resin mixture at 80° C. for 38 h. Then the films were further cured at 140° C. for 2 h under vacuum followed by post-curing at 185° C. for 1 h under vacuum. The effect of the CNWs on the curing behaviour of the phenolic resin was investigated by differential scanning calorimetry (DSC) analysis. DSC thermograms for the pure phenolic resin and its reinforced form with CNWS do not show big differences. However, in the presence of CNWs, the total heat of reaction underlying the cure exotherm increases significantly. For example the heat of cure measured at 5° C./min increased from 380 J/g for the pure resin up to 536 J/g for the resin modified with 5 wt % CNWs. From the dynamic mechanical analysis results, the reinforcing effect of CNWs on the phenolic resin is clearly seen over the entire temperature range. However, the increase of the modulus with CNWs loading was relatively modest compared to the thermoplastic based nanocomposites. The Liu and Laborie explained lack of improvement as the phenolic resin itself has higher stiffness than the thermoplastic resins.

Polymeric MDI are used for different applications, such as flexible polyurethane foam, rigid polyurethane foam, coatings, adhesives sealants, elastomer, and binder. Auad et al. (2008) dispersed NC in dimethylformamide (DMF) by ultrasonication (40 kHz, 160 W, TESTLAB ultrasonic bath, model TB04, Buenos Aires, Argentina) and subsequently incorporated into a DMF-PU solution. Then films of reinforced PUs (about 0.5 mm in thickness) containing 0, 0.1, 0.5 and 1 wt % fibers were obtained by casting the mixture in an open mold and drying in a convection oven at 80° C. for 24 h. After testing the film, they found that the composites showed higher tensile modulus and strength than unfilled films (53% modulus increase at 1 wt % nanocellulose), with higher elongation at break. Cao et al. (2007) used flax cellulose nanocrystals as fillers in making nanocomposite materials with waterborne polyurethane. They mixed the two aqueous suspensions homogeneously and obtained the nanocomposite films by casting and evaporating. The morphology, thermal behavior, and mechanical properties of the films were investigated by means of attenuated total reflection Fourier transform infrared spectroscopy, wide-angle X-ray diffraction, differential scanning calorimetry, scanning electron microscopy, and tensile testing. The films showed a significant increase in Young's modulus and tensile strength from 0.51 to 344 MPa and 4.27 to 14.96 MPa, respectively, with increasing filler content from 0 to 30 wt %. Of note is that the Young's modulus increased exponentially with the filler up to a content of 10 wt %. The synergistic interaction by hydrogen bondings and physical-chemical mechanisms between fillers and between the filler and WPU matrix played an important role in reinforcing the nanocomposites. Wang et al. (2010) studied the role of starch nanocrystals (SN) and cellulose whiskers (CW) in synergistic reinforcement of waterborne polyurethane. They used similar method as Cao et al. (2007) but they used TEM and x-ray diffraction pattern to describe the nano material and showed that X-ray diffraction pattern can tell the differences in different crystals. They found that the increase of tensile strength was most obvious at 1 wt. % SN for WPU/SN and 0.4 wt. % CW for WPU/CW. With a further addition of nanofiller content, the mechanical properties of binary nanocomposite films dropped due to the formation of aggregation of the nanofillers. To avoid the aggregation and utilize the different geometrical characteristics of SN and CW, they were used together and a dramatic increase of tensile strength of WPU was observed. Chen et al. (2008) studied the impact of filling low loading of starch nanocrystals (StNs) as a nano-phase on waterborne polyurethane (WPU) composite. It was noting that the resultant StN/WPU nanocomposites showed significant enhancements in strength, elongation and Young's modulus. The key role of StN in simultaneous reinforcing and toughening was activating surface and hardening the interface of transferring stress and contributed to enduring stress, respectively. The preserving of original structure and interaction in WPU matrix was also the essential guarantee of improving mechanical performances. As the StN loading increased, the self-aggregation of StNs caused size expansion of nano-phase along with the increase of number, and hence they decreased the mechanical performances. It was also verified that chemical grafting onto the StN surface didn't favor enhancing the strength and elongation, due to inhibiting the formation of physical interaction and increasing network density in nanocomposites.

This present invention is meant to overcome many of these disadvantages.

### SUMMARY OF THE INVENTION

In an aspect of the present invention, there is provided a thermoset resin system for a wood adhesive comprising: a thermoset resin, a cellulose nanocrystal, and 30 to 60% weight of moisture, wherein the cellulose nanocrystal is reinforcing the phenolic thermoset resin system.

In accordance with one aspect of the present invention, there is provided a powder resin system comprising a phenolic component, a formaldehyde component, and a cellulose nanocrystals (CNC), wherein the system comprises 2 to 8% weight of moisture per resin system.

In accordance with another aspect of the system herein described, the system comprises from 4 to 6% weight of moisture per resin system.

In accordance with yet another aspect of the system herein described, the system comprises from 0.5 to 4% weight of cellulose nanocrystals per resin system.

In accordance with still another aspect of the system herein described, the phenolic component is phenol.

In accordance with yet still another aspect of the system herein described, the phenolic component is phenol and lignin.

In accordance with a further aspect of the system herein described, comprising a molar ratio of formaldehyde:phenol component from 1.8:1 to 3:1.

In accordance with yet a further aspect of the system herein described, comprising a weight ratio of hydroxide to formaldehyde from 0.03:1 to 0.3:1.

In accordance with another aspect of the present invention, there is provided a liquid resin system comprising a phenolic component, a formaldehyde component, and a cellulose nanocrystals, wherein the system comprises 35 to 55% weight of solids in the resin system and the cellulose nanocrystals is incorporated into an intimate contact with the system, whereby the incorporation is through in-situ polymerization.

In accordance with still a further aspect of the system herein described, the system comprises from 35 to 55% and preferably from 40 to 45% weight solids per resin system.

In accordance with yet still a further aspect of the system herein described, the system comprises from 0.1 to 2%, preferably from 0.5 to 1% weight of cellulose nanocrystals per resin system.

In accordance with one embodiment of the system herein described, the phenolic component is phenol.

In accordance with another embodiment of the system herein described, the phenolic component is phenol and lignin.

In accordance with yet another embodiment of the system herein described, comprising a molar ratio of formaldehyde:phenol component of from 1.8:1 to 3:1.

In accordance with still another embodiment of the system herein described, comprising a weight ratio of hydroxide to formaldehyde from 0.03:1 to 0.3:1.

In accordance with yet another aspect of the present invention, there is provided a method of producing a liquid resin adhesive system comprising the steps of: providing a phenolic compound; providing a formaldehyde compound; providing a cellulose nanocrystals, providing an alkaline hydroxide, mixing the phenolic compound and the cellulose nanocrystals with water and the alkaline hydroxide at a constant temperature making a phenolic blend; methylolation of the phenolic blend by adding the formaldehyde compound to the phenolic blend to start the polymerization through condensation and controlling the temperature producing a reaction mixture; and stopping the polymerization by cooling the reaction mixture until the mixture reaches a specific viscosity.

In accordance with yet still another embodiment of the method herein described, further comprising adding more formaldehyde and/or alkaline hydroxide to the reaction mixture during the polymerizing step.

In accordance with still another aspect of the present invention, there is provided a method for producing a powder resin adhesive system comprising the steps of providing a phenolic compound; providing a formaldehyde compound; providing a cellulose nanocrystals, providing an alkaline hydroxide, mixing the phenolic compound and the formaldehyde compound with water at a constant temperature making a resin mix having a specified solids weight % in the mix; polymerizing the resin mix by adding the alkaline hydroxide to the resin mix to start the polymerization and controlling the temperature producing a reaction mixture; monitoring and adjusting the temperature and pH of the reaction mixture; stopping the polymerization by cooling the reaction mixture until the mixture reaches a specific viscosity and an alkaline pH to produce a phenolic resin, mixing the cellulose nanocrystals with the phenolic resin and drying the phenolic resin to produce the powder.

In accordance with a further embodiment of the method herein described, the phenolic compound is at least one of phenol or lignin.

In accordance with yet a further embodiment of the method herein described, the formaldehyde is a para-formaldehyde.

In accordance with still a further embodiment of an oriented strand board or a plywood produced with the resin system herein described.

In accordance with yet still another aspect of the present invention, there is provided a liquid thremoset resin system comprising: a diisocyanate, a cellulose nanocrystal, wherein the system comprises 40-60% weight of water content per resin system.

In accordance with an embodiment of the system herein described, the system comprises from 0.2% to 2% weight of cellulose nanocrystals per resin system

In accordance with another embodiment of the system herein described, the diisocyanate is polymeric methylene diphenyl diisocyanate (pMDI).

In accordance with yet another embodiment of the system herein described, wherein the pMDI is an emulsifiable polymeric MDI.

In accordance with still another embodiment of the system herein described, wherein the system comprises from 40-60% of diisocyanate per resin system.

In accordance with yet still another embodiment of the system herein described, wherein the system is stable for one to three hours.

In summary, few attempts have been made to incorporate MFC, CNW into phenolic resins, specifically to act as a matrix. However, when CNC is incorporated into the phenolic resin matrix, several problems and/or issues have arisen: 1) commercial phenolic resins can be in the form of powder or liquid instead of aqueous solution; 2) when incorporating NCW or MFC into a phenolic resin, the organic solvent used would have to mix the NCW or MFC/PF together well before being removed, and the resulting mixture would need to be further mixed by kneading at an elevated temperature or by dry-blending the NCW or MFC with phenolic resin and further mixing by kneading at an elevated temperature, and 3) the resulting NCW or MFC/phenolic resin mixtures are in most cases, suitable as structural composites or as a reinforcement agent to improve certain properties.

The present invention provides methods and manufacturing process to overcome these problems by 1) applying cellulose nanocrystals (CNC) in aqueous dispersion, in which the CNC was well dispersed in water with assistance of phenolic polymers under an alkaline condition; 2) adopting in-situ polymerization technique to incorporate CNC into phenolic resin by which the resulted polymers have intimate contacts with CNC and thus improve the interaction of CNC with polymers; 3) creating the CNC-phenolic adhesive in an aqueous solution; 4) generating the CNC-phenolic composite powder through spray drying, which can be used as powder adhesives for wood composites and as polymer composites after curing; 5) making the wood composites with CNC/phenolic composite adhesives.; and 6) making CNC reinforced phenolic resin composites. The present invention provides a resin system, comprising a nano-crystalline cellulose and one or more polymers, which is phenolic resin, which either phenol-formaldehyde resin or lignin-phenol-formaldehyde resin.

By “resin system” is herein meant a combination of two or more components which forms, and functions as, a wood adhesive, and a nano-composite.

The present invention also relates to a method of making resin system, and methods for making ligno-cellulosic composites from renewable materials.

Disclosed herein is preparation of the CNC-PF and CNC-PF-lignin composites powder; preparation of the CNC-PF and CNC-PF-lignin composites in a liquid form through in-situ polymerization/adhesive formulations: adhesives compositions and methods for.

One variant of the resin system described herein, is a powder form, including at least one cellulose nanocrystals (CNC) aqueous dispersion, at least one phenol-formaldehyde resin component with low molecular weight (viscosity of 50-100 centipoise under resin solid of 40-45% wt). These two components were mixed and the solid content was adjusted to 20-35% wt (preferable 25-30% wt) through a high shear mixer under between 500 and 4500 RPM for a certain period of time (5-50 minutes), preferable 1000-2000 RPM for 10-20 minutes. The mixture was dried through a spray dryer, in which the outlet temperature was set at 80-100° C., preferably 85-95° C.

Another variant of the resin system described herein is a, powder form, including at least one cellulose nanocrystals (CNC) aqueous dispersion, at least one lignin-phenol-formaldehyde resin component with low molecular weight (viscosity of 50-100 centipoise under resin solid of 40-45% wt). These two components were mixed and the solid content was adjusted to 20-35% wt (preferable 25-30% wt) through a high shear mixer under between 500 RPM and 4500 RPM for a certain period of time (5-50 minutes), preferable 1000-2000 RPM for 10-20 minutes. The mixture was dried through a spray dryer, in which the outlet temperature was set at 80-100° C., preferable 85-95° C.

A further variant of the resin system described herein, is a liquid form, including at least one CNC dispersion, at least one phenol component, and at least one formaldehyde component. The mix was reacted at elevated temperatures for a certain period of time. The resin solid was 35-55% wt, preferably 40-50% wt.

Yet another variant of the resin system described herein, is liquid form, including at least one CNC dispersion, at least one lignin component, at least one phenol component, and at least one formaldehyde component. The mix was reacted at elevated temperatures for a certain period of time. The resin solid was 35-55% wt, preferably 45-50% wt.

Still another variant of the resin system, is a composition was produced by mixing at least one CNC dispersion, and at least one phenolic resin (either phenol-formaldehyde resin or lignin-phenol-formaldehyde resin) with solid contents between 35 and 55% wt and viscosities between 150 and 2000 centipoise, preferable 40-45% wt. For wood composite applications, the viscosity is preferable 150-200 centipoise for OSB application, and preferable 500-1000 centipoise for plywood applications.

Disclosed herein is also preparation of the CNC-polymeric methylene diphenyl diisocyanate (hereafter pMDI) binder in a liquid form/adhesive formulations: adhesives compositions and methods for.

A variant of the resin system described herein, is a liquid form, including at least one CNC aqueous dispersion, at least one pMDI. The mixture was stable in the form of emulsion for a certain period of time. The active component content was 35-70% wt, preferably 45-55% wt.

Also disclosed herein are lignocellulosic composites comprised of the lignocellulosic materials and resin system, the methods for making resin system, and the methods for making the composites.

Also disclosed herein are phenolic resin composites comprised of resin system (first variant and second variant) and the methods for making polymer composites.

### BRIEF DESCRIPTION OF THE DRAWING

FIG. 1 is a graph of storage modulus as a function of temperature (PPF0: 0% CNC in PF resin, PPF1: 0.5% CNC in PF resin, and PPF3: 2.0% CNC in PF).

### DETAILED DESCRIPTION OF THE INVENTION

For easier understanding, a number of terms used herein are described below in more details:

“Lignin” generally refers to a group of phenolic polymers that give strength and rigidity to plant materials. Lignins are complex polymers, and tend to be referred to in generic terms. Lignins may include, for example, industrial lignin preparations, such as kraft lignin, lignosulfonates, and organosolv lignin from by-products of bio-ethanol process, and analytical lignin preparation, such as dioxane acidolysis lignin, milled wood lignin, Klason lignin, cellulolytic enzyme lignin, and etc.

“Lignin component” represents any lignin-containing materials. Lignin component can be derived from industrial lignin preparation, analytical lignin preparation, and etc, which are from renewable resources, especially from lignocelluloses. The lignin component can be a material or compositions, which is modified or treated or purified portion of lignin.

“Lignocelluloses materials” include all plant materials. For example, materials include wood materials (such as wood strands, wood fibers or wood chips or wood particles), grass materials (such as hemp or flax), grain materials (such as the straw of rice, wheat, corn), and etc.

A “phenolic compound” is defined as a compound of general formula ArOH, where Ar is phenyl (phenol), substituted phenyl or other aryl groups (e.g. tannins) and a lignin and combinations thereof. The phenolic compound may be selected from the group consisting of phenol, a lignin and combinations thereof.

In a preferred embodiment the phenolic compound is phenol. In another preferred embodiment the phenolic compound is a combination of phenol and a lignin. Starting materials are understood as all compounds and products added to produce the adhesive polymer disclosed herein.

A formaldehyde compound may be selected from the group consisting of formaldehyde and paraformaldehyde and combinations thereof. The paraformaldehyde has the formula HOCH2(OCH2)nCH2OH, in which n is an integer of 1 to 100, typically 6 to 10. Paraformaldehyde will be decomposed to formaldehyde before it methylolation reaction with phenol or lignin.

“Cellulose nanocrystals (CNC)” includes all cellulose nanocrystals made from different resources, such as wood (softwoods and hardwoods), plants (for example, cotton, ramie, sisal, flax, wheat straw, potato tubers, sugar beet pulp, soybean stock, banana rachis etc), tunicates, algae (different species: green, gray, red, yellow-green, etc.), bacterials [common studied species of bacteria that produces cellulose is generally called Gluconacetobacter xylinus (reclassified from Acetobacter xylinum)], and etc. CNC may also be defined as nanocrystalline cellulose (NCC).

One such cellulose nanocrystals (CNC) are a cellulosic rod-like shaped nanomaterial and are extracted from a variety of naturally occurring cellulose sources such as wood pulp, cotton, some animals, algae and bacteria.

NCCs or CNCs can be obtained by various processes but the most common extraction technique relies on a chemical hydrolysis of the cellulose source under harsh acidic conditions, which releases the rigid crystalline parts of the microfibrils. Typical dimensions for CNCs are generally from 3 to 20 nanometers in cross section and from several tens of nanometers up to several microns in length. CNC is characterized by a high degree of crystallinity with an axial ratio ranging generally between few tens up to several hundreds.

The scope of the claims should not be limited by the preferred embodiments set forth in the examples, but should be given the broadest interpretation consistent with the description as a whole.

Phenol-formaldehyde (PF) resins are known to be prepared from two main chemicals that are reacted at elevated temperatures through methylolation and condensation to form a phenolic polymer. The polymer formation is strongly related to the molar ratio of phenol to formaldehyde, and the pH at which the reaction is carried out. The phenolic resin is called Novolac resin when the molar ratio of formaldehyde to phenol is less than 1 and at low pH. The phenolic resin is called Resol type when the molar ratio of formaldehyde to phenol is higher than 1, and the pH is higher than 7. Resol type phenolic resins will crosslink, usually at elevated temperatures.

The basic purposes of the present invention is 1) to incorporate CNC into phenol-formaldehyde resin system or lignin-phenol-formaldehyde resin system in liquid form or powder form, 2) to improve the bonding properties and mechanical properties of wood composites made with such formulations either in liquid form or powder form, and 3) to improve mechanical and thermal properties of CNC-phenol-formaldehyde molded products and/or CNC-lignin-phenol-formaldehyde molded products made with such formulations in powder form.

More specifically, the collective purposes of the present invention are 1) to incorporate CNC into phenolic resin with low viscosity in liquid form and make CNC-phenolic resin in powder form through spray drying process, 2) to provide a process for preparing thermoset resin in powder form wherein a CNC is well distributed into lignin-phenol-formaldehyde resin and/or phenol-formaldehyde resin which CNC has strong intimate contact with lignin-phenol-formaldehyde resin and/or phenol-formaldehyde resin, which can be used as powder resin for wood composites and for molded components, 3) to incorporate CNC into phenolic resin (either lignin-phenol-formaldehyde resin or straight phenol-formaldehyde resin) in liquid form, which can be used for wood composites, and 4) to incorporate CNC into isocyanate and make CNC-isocyanate binder (adhesive) in liquid form for wood composites.

Below we described the general chemistry associated with forming the final resin mixtures.

CNC-Phenolic Resin Formulations in Powder Form

The first step of the process according to the invention consists of mixing lignin if applicable, with phenol, formaldehyde (or paraformaldehyde), and a base and letting the so obtained mixture react at elevated temperatures. The order of addition of the above starting compounds is not important, but it is preferred to load phenol first, then water, later on lignin, after that, formaldehyde in the form of para-formaldehyde, and then raise the temperature to 50-60° C., and then load sodium hydroxide in the form of a solution containing 50% by weight of sodium hydroxide. The so prepared mixture is heated to temperatures ranging between 60-75° C., preferably ˜70° C., for a period of 1 to 2 hours, for example. In this step, the methylolation reaction takes place in which formaldehyde reacts on the ortho position of the phenol and with available sites on the lignin.

The second step of process according to the invention consists of loading more sodium hydroxide in the form of a solution containing 50% by weight of sodium hydroxide in the system, and the temperature is maintained same as the first step. The period of time is, for example, 10 minutes to 1 hour. The methylolation reaction continues.

Such a two-stage processing is actually important. Indeed, the same process could be made in only one stage at different temperatures, such as 80-95° C., such processing may not produce the same resin, and the resin obtained in one stage may not have the same quality as the resin produced in two steps.

The third step of process according to the invention consists of raising the temperature to 75-95° C. for condensation reaction of methylolated lignin with methylolated phenol, preferably 80-85° C. for a certain period of time. At this stage, controlling the reaction temperature is important. Otherwise, a proper viscosity may not be achieved. The viscosity is varied for different applications, such as around 70-80 cps for spray drying to make powder resin, around 100-200 cps for OSB with solids content around 45-50%, around 250-3000 cps or over for plywood making.

In applications, the amounts of raw materials added at each stage, the temperature at which the addition is carried out and/or the molar ratios of formaldehyde to phenol may vary depending on the needs. In practices, the molar ratio of formaldehyde to phenol preferably ranges from 1.8:1 to 3.0:1. More preferably, the molar ratio ranges from 2.2:1 to 2.8:1 to achieve better results; the weight ratio of base (sodium hydroxide and/or potassium hydroxide) to phenol or lignin (if applicable) ranges from 0.03:1.00 to 0.30:1.00. More preferably, the weight ratio ranges from 0.08:1.00 to 0.15:1.00 to achieve better results.

The fourth step of process according to invention consists of a) preparing the CNC aqueous dispersion through soaking the required amount of CNC in water for a few hours to make sure the CNC is well dispersed in water (it could become gel-like liquid if the CNC concentration reaches to ≧3-5% wt) with different methods, such as sonication, high shear mixing etc.; b) transferring pre-prepared CNC dispersion into phenol-formaldehyde resin (PF) or lignin-phenol-formaldehyde (LPF) resins and adjusting the solids content to 25-30% wt through the addition of water if necessary; c) mixing the mixture of CNC-phenolic resin (CNC-PF and/or CNC-LPF) with a high shear mixer under 2000 RPM or higher for 10 min or sufficient time to obtain uniform CNC-PF (post blending) or CNC-LPF (powdered CNC-PF and/or CNC-lignin-PF) system.

The fifth step of the process according to invention consists of converting the liquid CNC-LPF and/or CNC-PF system into a powder form with a certain feed rate (depending on the capacity of the spray-dryer). The outlet temperature was set at 85-95° C. through a pulverization spray dryer.

It is also possible to add part of CNC dispersion in the first step of the process of mixing lignin if possible, with phenol, formaldehyde (or paraformaldehyde), and a base and letting the so obtained mixture react at elevated temperature, and continue with second, third steps of process. In this case, the CNC is incorporated with phenolic resin system via in-situ polymerization. It also can combine fourth step and fifth step of the process to convert the liquid CNC-LPF and/or CNC-PF system into powder form.

CNC-Phenolic Resin Formulations in Liquid Form

The steps of the process according to the invention consist of similar first three steps as CNC-phenolic resin formulation in powder form described in previous section above except CNC was added in the first step in powder form.

Below we list some specific examples of the general chemistry just described.

### Example 1

### Preparation of Phenol-Formaldehyde Adhesive in Liquid Form for Making Powder Resin

In this example, all materials are counted by weight parts to prepare a formulation of phenol (98%): 750 parts by weight, paraformaldehyde (91%): 645 parts by weight, sodium hydroxide (50 wt %): 195 parts by weight, and water: 1550 parts by weight. The “n” value for formaldehyde is 1 to 100, and preferably 6 to 10.

In a 4-L reaction vessel, phenol, paraformaldehyde, and part of water (850 parts) were added to make a medium having a solids content around 50 wt %. The system was heated to around 50° C., and the first part of sodium hydroxide (75 parts) was added. The system was heated to approximately 70° C. and was kept at this temperature for one and a half hours. Subsequently, the second part of sodium hydroxide (60 parts) and water (300 parts) were added, with the temperature maintained at approximately 70° C. for another half an hour. Afterwards, the temperature was increased to 80-90° C., and the viscosity was monitored. When the viscosity of the resin system reached to 20-30 cps, pH was monitored and around 20 parts of sodium hydroxide (50% wt) were added to bring pH to over 10. When the viscosity reached to 70-100 cps and pH around 10.4, the reaction was terminated by cooling the reactor to approximately 30° C. The contents were transferred to a container and stored in a cold room for later use. The adhesive was coded PF. The viscosity of PF was 100 cps and the pH of the PF was 10.45.

### Example 2

### Preparation of Lignin-Phenol-Formaldehyde Adhesive in Liquid Form for Making Powder Resin

In this example, all materials are counted by weight parts to prepare a formulation of phenol (98%): 660 parts by weight, kraft softwood lignin from black liquor (prepared by Pulp & Paper Division of FPInnovations) (partially oxidized kraft lignin obtained from the LignoForce System™”) (90%): 350 parts by weight, paraformaldehyde (91%): 565 parts by weight, sodium hydroxide (50 wt %): 400 parts by weight, and water: 1730 parts by weight.

In a 4-L reaction vessel, phenol, kraft softwood lignin, paraformaldehyde, some of the sodium hydroxide (80 parts), and some of the water (1400 parts) were added to make a medium having a solids content around 50 wt %. The system was heated to approximately 70° C. and was kept at this temperature for one and a half hours. Subsequently, the second portion of sodium hydroxide (100 parts) and remaining water were added, with the temperature maintained at approximately 70° C. for another half an hour. Afterward, the temperature was increased to 80-90° C., and the viscosity was monitored. When the viscosity of the resin system reached to around 50 cps, some sodium hydroxide was loaded to being up the pH to over 10. Viscosity of resin was checked every 20 minutes. When the viscosity reached to 70-100 cps, the reaction was terminated by cooling the reactor to approximately 30° C. The contents were transferred to a container and stored in a cold room for later use. The adhesive was coded LPF. The viscosity of LPF was 97 cps and the pH of the LPF was 10.26. Another batch was synthesized under the same condition and two batches were mixed together. [Phenol (660 parts), kraft softwood lignin (360 parts), paraformaldehyde (565 parts) mentioned in previous paragraph were loaded in except part of sodium hydroxide and part of water].

### Example 3

### Preparation of CNC-Lignin Phenol-Formaldehyde Composites in Powder Form and CNC-Phenol-Formaldehyde Composites in Powder Form

The PF made in Example 1 and LPF made in Example 2 were used to prepare nano-crystalline cellulose-phenol-formaldehyde (CNC-PF) and cellulose nanocrystals-lignin-phenol-formaldehyde (CNC-LPF) adhesives through post-blending with CNC dispersion in phenolic resin and drying through a spray dryer. The LPF (and/or PF) was divided into several portions, in which one was used as a control, and other portions for adding different levels of CNC. The procedure is described as follows:
1) Soaking and dispersing the required amount of CNC in water overnight;
2) Transferring CNC water dispersion into phenolic resin and adding water to solids content about 28% (detailed in Table 1);
3) Mixing the mixture of CNC-LPF in liquid form and/or CNC-PF in liquid form at a speed of 2000 RPM for 10 minutes with a high shear mixer to obtain uniformly distributed CNC-LPF or CNC-PF resin formulations;
4) Drying the uniformly distributed CNC-LPF and/or CNC-PF formulations with a pulverization spray dryer (Model: BE-1037, Series: Bowen) from Incotech Inc. (Bennières, Quebec, Canada) (outlet temperature of 88-91° C. and feed rate of 48 gram per minute). (please see Table 1 for detailed information of CNC-LPF and CNC-PF powder)

TABLE 1
Information about spray drying of CNC-phenolic resin

| | | | | Mixture | | | |
|---|---|---|---|---|---|---|---|
| | | | | before | | | |
| | Liquid resin | | CNC | drying² | | CNC | MC of |
| Powder | | Solid | loading¹ | Solid | Yield | in powder | powder³ |
| Code | Code | (%) | (%) | (%) | % | % | % |
| PLPF0 | LPF | 41 | 0 | 29.5 | 88.3 | 0 | 4.4 |
| PLPF1 | LPF | 41 | 0.20 | 28.9 | 88.5 | 0.5 | 4.5 |
| PLPF2 | LPF | 41 | 0.40 | 29.4 | 86.2 | 1.0 | 4.4 |
| PLPF3 | LPF | 41 | 0.80 | 29.4 | 83.6 | 2.0 | 4.0 |
| PLPF4 | LPF | 41 | 1.60 | 29.7 | 79.4 | 3.9 | 4.6 |
| PPF0 | PF | 39 | 0 | 27.7 | 74.8 | 0 | 5.7 |
| PPF1 | PF | 39 | 0.20 | 27.8 | 83.2 | 0.5 | 5.9 |
| PPF3 | PF | 39 | 0.80 | 28.0 | 74.6 | 2.0 | 5.8 |

¹Based on the weight of liquid resin;
²before drying, solid content was measured for mixture at 121° C. for 2 hours;
³(actual powder weight − powder weight after oven dry at 103° C. for 24 hours)/powder weight after oven dry at 103° C. for 24 hours × 100

### Example 4

### Oriented Strand Board (OSB) Panels Made with CNC-LPF Composite Powder Adhesive, and CNC-PF Composite Powder Adhesive

Three-layer OSB panels were made with CNC-phenolic resins prepared in Example 3. These resins were only used in surface layers and 100% commercial phenolic powder resin was used in the core layer, under the pressing conditions listed in Table 2. Detailed information about the resins in surface and core layers is listed in Table 3.

TABLE 2
OSB panel manufacturing conditions
with CNC-phenolic powder resin

| Target panel density (OD basis) | 40 | lbs/ft³ |
|---|---|---|
| Mat dimension | 20 in × 23 in | |
| Target panel thickness | 11.1 mm ( 7/16 in) | |
| Mat composition: face/core/face | 25/50/25 | |
| Resin dosage | | |
| Face: | 3% | |
| Core: | 3% | |
| Wax dosage | | |
| Face: | 1% | |
| Core: | 1% | |
| Face wafer moisture before resin and wax | 2% | |
| Core wafer moisture before resin and wax | 2.5% | |
| Core moisture after resin and wax | 3.5% | |
| Face moisture after resin and wax | 7-8% | |
| Press temperature (° C.) | 220° | C. |
| Total press time | 150 seconds (daylight | |
| | to daylight) | |
| Close time | 25 | seconds |
| Degas | 25 | seconds |

| | |
|---|---|
| Replicate | 2 |

TABLE 3
OSB panels with different resin formulations

| | | | | MC of face | | MC of core |
|---|---|---|---|---|---|---|
| | | Solid | CNC | mat | | mat |
| No. | Face resin | % | % | % | Core resin | % |
| 1 | Com. PF1 | 55.3 | 0 | 7 | Com. PF3 | 4 |
| 2 | PLPF0 | 95.6 | 0 | 7 | Com. PF3 | 4 |
| 3 | PLPF1 | 95.5 | 0.49 | 7 | Com. PF3 | 4 |
| 4 | PLPF2 | 95.4 | 0.98 | 7 | Com. PF3 | 4 |
| 5 | PLPF3 | 96.0 | 1.95 | 7 | Com. PF3 | 4 |
| 6 | PLPF4 | 95.4 | 3.90 | 7 | Com. PF3 | 4 |
| 7 | PPF0 | 94.3 | 0 | 7 | Com. PF3 | 4 |
| 8 | PPF1 | 94.1 | 0.49 | 7 | Com. PF3 | 4 |
| 9 | PPF3 | 94.2 | 1.98 | 7 | Com. PF3 | 4 |
| 10 | Com. PF2 | 96.0 | 0 | 7 | Com. PF3 | 4 |

Com. PF1: commercial liquid PF (surface);
Com. PF2: commercial powder PF (surface);
PLPF: powder CNC-lignin-PFs via spray drying;
PPF: powder CNC-PF resins via spray drying;
Com. PF3: commercial power PF for core

The physical and mechanical properties of OSB panels, including 24-h thickness swelling (TS), 24-h water absorption (WA), internal bond (IB) strength, modulus of elasticity (MOE) and modulus of rupture (MOR) were measured according to CSA O437.1-93 standard and the results are illustrated in Tables 4, 5, and 6.

TABLE 4
Mechanical and physical properties of OSB panels made with CNC-phenolic resins

| | | Density | | | Density | IB³ |
|---|---|---|---|---|---|---|
| No. | Face resin | (kg/m³) | 24-h TS¹ (%) | 24-h WA² (%) | (kg/m³) | (MPa) |
| 1 | Com. PF1 | 671 ± 16 | 23.4 ± 3.2 | 38.1 ± 3.3 | 655 ± 13 | 0.33 ± 0.07 |
| 2 | PLPF0 | 677 ± 15 | 19.5 ± 1.9 | 31.9 ± 0.8 | 643 ± 22 | 0.35 ± 0.05 |
| 3 | PLPF1 | 677 ± 17 | 18.3 ± 1.9 | 32.1 ± 0.3 | 650 ± 15 | 0.32 ± 0.05 |
| 4 | PLPF2 | 678 ± 15 | 19.8 ± 0.4 | 33.7 ± 2.7 | 648 ± 18 | 0.34 ± 0.05 |
| 5 | PLPF3 | 661 ± 21 | 18.0 ± 1.4 | 33.9 ± 0.2 | 644 ± 18 | 0.39 ± 0.09 |
| 6 | PLPF4 | 665 ± 19 | 17.7 ± 0.6 | 31.8 ± 0.5 | 646 ± 8 | 0.36 ± 0.07 |
| 7 | PPF0 | 642 ± 4 | 18.3 ± 0.2 | 36.2 ± 1.2 | 649 ± 20 | 0.32 ± 0.10 |
| 8 | PPF1 | 678 ± 10 | 17.9 ± 0.6 | 33.5 ± 1.0 | 648 ± 25 | 0.41 ± 0.04 |
| 9 | PPF3 | 621 ± 30 | 17.1 ± 1.5 | 38.2 ± 3.9 | 670 ± 34 | 0.35 ± 0.08 |
| 10 | Com. PF2 | 622 ± 30 | 19.5 ± 1.0 | 39.2 ± 3.6 | 648 ± 12 | 0.41 ± 0.07 |

^{1 & 2}Average of two specimens per panel;
³average of 8 specimens per panel

TABLE 5
Static bending properties of OSB panels made with
CNC-phenolic resins (tested under dry condition)¹

| | Face resin | | Density | MOE | MOR |
|---|---|---|---|---|---|
| No. | code | CNC (%) | (kg/m³) | (MPa) | (MPa) |
| 1 | Com. PF1 | 0 | 632 ± 61 | 2843 ± 606 | 18.1 ± 8.0 |
| 2 | PLPF0 | 0 | 688 ± 28 | 4102 ± 534 | 29.5 ± 5.6 |
| 3 | PLPF1 | 0.5 | 629 ± 19 | 2767 ± 311 | 18.3 ± 5.4 |
| 4 | PLPF2 | 1.0 | 631 ± 16 | 3305 ± 149 | 19.1 ± 2.1 |
| 5 | PLPF3 | 2.0 | 652 ± 31 | 3940 ± 1430 | 28.3 ± 10.5 |
| 6 | PLPF4 | 3.9 | 640 ± 9 | 4199 ± 564 | 31.3 ± 7.1 |
| 7 | PPF0 | 0 | 656 ± 29 | 3943 ± 339 | 24.5 ± 3.0 |
| 8 | PPF1 | 0.5 | 640 ± 29 | 3669 ± 836 | 24.7 ± 8.9 |
| 9 | PPF3 | 2.0 | 651 ± 31 | 3621 ± 659 | 26.1 ± 4.0 |
| 10 | Com. PF2 | 0 | 669 ± 26 | 3596 ± 859 | 23.3 ± 5.0 |

¹Average of 4 specimens per panel, in which two specimens were tested under top face up, and two specimens were tested under top face down,

TABLE 6
Static bending properties of OSB panels made with
CNC-phenolic resins (tested under wet condition)¹

| | Face resin | | Density | MOE | MOR |
|---|---|---|---|---|---|
| No. | code | CNC (%) | (kg/m³) | (MPa) | (MPa) |
| 1 | Com. PF1 | 0 | 654 ± 24 | 1326 ± 403 | 6.7 ± 1.8 |
| 2 | PLPF0 | 0 | 636 ± 17 | 1528 ± 142 | 8.1 ± 1.9 |
| 3 | PLPF1 | 0.5 | 656 ± 19 | 1773 ± 204 | 10.2 ± 1.2 |
| 4 | PLPF2 | 1.0 | 649 ± 37 | 2036 ± 422 | 12.0 ± 3.4 |
| 5 | PLPF3 | 2.0 | 644 ± 16 | 1977 ± 238 | 12.0 ± 2.8 |
| 6 | PLPF4 | 3.9 | 647 ± 37 | 2172 ± 350 | 12.5 ± 2.9 |
| 7 | PPF0 | 0 | 654 ± 13 | 2259 ± 465 | 11.9 ± 2.7 |
| 8 | PPF1 | 0.5 | 645 ± 24 | 1920 ± 316 | 10.9 ± 3.6 |
| 9 | PPF3 | 2.0 | 644 ± 9 | 2053 ± 378 | 11.9 ± 1.9 |
| 10 | Com. PF2 | 0 | 635 ± 17 | 1697 ± 346 | 10.6 ± 1.4 |

¹Average of 4 specimens per panel, in which two specimens were tested under top face up, and two specimens were tested under top face down. Specimens were soaked in water at 20° C. for 24 hrs before testing.

From Table 4, it can be seen that the addition of CNC into lignin phenolic resins could reduce the thickness swelling from 19.5% for the OSB made with PNCLPF0 (without CNC) to 17.7% for the OSB made with PNCLPF4 (CNC: 3.90%). The water absorption (WA) and internal bond (IB) strength were basically the same for the OSB made with and without CNC. Addition of CNC into phenolic resin did not significantly improve the MOE and MOR for the OSB panels at dry conditions (Table 5); however, it improved the wet bending strength of the OSB made with lignin phenolic resins from average values of 1528 MPa (MOE of OSB made with PNCLPF0) and 8.1 MPa (MOR of OSB made with PNCLPF0) to average values of 2172 MPa (MOE of OSB made with PNCLPF4) and 12.5 MPa (MOR of OSB made with PNCLPF4).

### Example 5

### In-Situ Polymerization of CNC Phenol-Formaldehyde Resin in Liquid Form

CNC was formulated with phenol (99 wt %) 150 parts by weight; formaldehyde (40% wt %) 240 parts by weight; sodium hydroxide (50 wt %) 55 parts, CNC (powder) 2.6 parts, and water 120 parts.

In a 1-L reactor vessel, phenol, one third of the caustic, two thirds of the water, and CNC were added and the system was heated to around 60° C. Subsequently, one half of the formaldehyde solution was added over 30 minutes and another one fourth of water was added. At this point, the system temperature was raised to 65-70° C. and kept constant for 30 minutes. The temperature was then raised to 80-85° C., kept at this level for one hour, and then decreased to 65-70° C. At this point, the remaining formaldehyde was added over 30 minutes as well as the remaining water. The system was kept at 65-70° C. for another 30 minutes. Subsequently, the remaining sodium hydroxide was added and the temperature was kept at 80-85° C. until the required viscosity (350 cps) was reached.

The reaction was terminated by cooling the system with cooling water to around 30° C. The resulting products were transferred to a container and stored in a cold room (4° C.) before use. The adhesive was coded as CNC-PF. The CNC content was 1 wt % based on the solids content of the polymer adhesive.

Yellow birch veneer strips (1.5 mm thick×120 mm wide×240 mm long) were cut from the veneer purchased from a local mill (with the long direction being parallel to the wood grains), and stored at −30° C. for certain time, then conditioned at 20° C. and 20% relative humidity (RH) for two weeks. The adhesive polymer formulations prepared above were applied to one side of each face layer (the manufacturing condition for 3-ply plywood panel making is given in Table 7). After manufacturing, the panels were conditioned at 20° C. and 20% RH until reaching consistent moisture content. These three-ply plywood samples were then cut into testing specimen sizes (25 mm wide×80 mm long) for a plywood shear test. At least thirty specimens were cut from each plywood panel. Half of the specimens was tested in the pulled open mode while the other half of the specimens was tested in the pulled closed mode. The cross-section of the test samples was 25 mm by 25 mm. Specimens were tested wet after 48 hours of soaking in 20° C. running water.

TABLE 7
the 3-ply plywood composites manufacturing conditions

| Wood species | Yellow birch | |
|---|---|---|
| Thickness of veneer | 1.5 | mm |
| Plywood | 3-ply plywood | |
| Resin spread rate on face ply | 200-220 | g/m² |
| Open assembly time | 2-20 | minutes |
| Close assembly time | 2-10 | minutes |
| Temperature | 150° | C. |
| Pressure | 1500 | kPa |
| Pressing time | 5 | min |
| Pressure release time | 30 | sec. |

The test results are listed in Table 8 as follows:

TABLE 8
Three-ply plywood properties with/without CNC

| | Test after 48 hr soaking | | Test after boiling-drying-boiling | |
|---|---|---|---|---|
| | Shear | Wood | Shear | Wood |
| | strength | failure | strength | failure |
| Code | (MPa) | (%) | (MPa) | (%) |
| Commercial | 1.79 ± 0.42 | 64 | 1.73 ± 0.41 | 50 |
| PF | | | | |
| PF (lab- | 1.88 ± 0.53 | 88 | 2.06 ± 0.46 | 29 |
| synthesized) | | | | |
| CNC-PF | 2.58 ± 0.61 | 66 | 2.16 ± 0.56 | 51 |

It can be seen that the CNC-PF resin improved the bonding strength of 3-ply plywood after 48 hours soaking, in which the average value of bonding strength increased by about 37% comparing with the lab-synthesized PF resin; CNC-PF resin also improved the bonding strength after boiling-drying-boiling treatment.

### Example 6

### Post-Blending of Cellulose Nanocrystals with Lignin-Phenol-Formaldehyde Resin in Liquid Form

The lignin based phenol-formaldehyde resin was synthesized under the condition similar to Example 2. However, the pH of the resin was about 11.4. The CNC was post-blended with such resin as shown in Table 9. For all formulations, a high shear mixer was applied and all formulations were mixed at 2000 RPM for 15 minutes. CNCLPF0 was the sample without CNC. CNCLPF1 was prepared by: 1) dispersing CNC in water to make high concentration dispersion, and 2) adding the required lignin-phenol-formaldehyde resin in the CNC dispersion and 3) mixing them with a high shear mixer. CNCLPF2 and CNCLPF3 were prepared in the same way except CNC content: 1) directly adding the CNC in the resin, 2) using glass rod to mix CNC in resin, and 3) using a high shear mixer to obtain uniform formulation.

TABLE 9
CNC-LPF for plywood application

| | | | | CNC (%) | | | |
|---|---|---|---|---|---|---|---|
| | | | NVC¹ | (based on | (based on | Viscosity | |
| No. | Resin type | Code | (%) | liquid) | solid) | (cps) | Remarks |
| 1 | Lignin PF | CNCLPF0 | 40.5 | 0 | 0 | 1440 | 1) mixing |
| 2 | Lignin PF | CNCLPF1 | 38.0 | 0.73 | 1.92 | 1620 | 1) CNC in |
| | | | | | | | water; 2) load |
| | | | | | | | in LPF; 3) |
| 3 | Lignin PF | CNCLPF2 | 41.0 | 0.80 | 1.94 | 1560 | 1) CNC in LPF; 2) |
| | | | | | | | mixing |
| 4 | Lignin PF | CNCLPF3 | 41.4 | 1.45 | 3.50 | 2340 | 1) CNC in LPF; 2) |
| | | | | | | | mixing |

¹Non-Volatile Content (NVC): measured at 125° C. for 105 min;

The 2-ply plywood samples with such formulations were made with cross-section of 10 mm by 20 mm. The temperature was 150° C. and the press time was 3 minutes. The detailed information on the panel making is listed in Table 10.

TABLE 10
2-ply Plywood composites making conditions

| Wood species | Sliced yellow birch | |
|---|---|---|
| Thickness of veneer | ⅝″ | |
| Plywood | 2-ply | |
| Resin spread rate on face ply | 1.1-1.2 | mg/cm² |
| Temperature | 150° | C. |
| Pressure | 1000 | kPa |
| Pressing time | 3 | min |

| | |
|---|---|
| Pressure release time | 0 |

After samples were made, and they were stored in a conditioning chamber for one week and then 5 specimens for each formulation were tested after 48 hour soaking in water (around 20° C.), and tested wet at a 10 mm/min speed using an MTS testing machine. The testing results are shown in Table 11.

TABLE 11
Properties of two-ply plywood panel made with lignin PF with/without CNC

| | | | CNC (%) | | Shear | |
|---|---|---|---|---|---|---|
| | | NVC¹ | (based on | (Based on | strength | |
| No. | Code | (%) | liquid) | solid) | (MPa) | Remarks |
| 1 | CNCLPF0 | 40.5 | 0 | 0 | 3.60 ± 0.68 | 1) Mixing |
| 2 | CNCLPF1 | 38.0 | 0.73 | 1.92 | 3.61 ± 0.31 | 1)CNC in water; 2) |
| | | | | | | load in LPF; 3) |
| 3 | CNCLPF2 | 41.0 | 0.80 | 1.94 | 4.09 ± 0.91 | 1) CNC in LPF; 2) |
| | | | | | | mixing |
| 4 | CNCLPF3 | 41.4 | 1.45 | 3.50 | 4.25 ± 0.74 | 1) CNC in LPF; 2) |
| | | | | | | mixing |

From Table 11, it can be seen that adding CNC in lignin-PF resins through post-blending can improve the wet shear strength, in which the average value increased by about 13.6% with 1.94% CNC in the resin (No. 3 in Table 11), and 18.1% with 3.5% CNC in the resin comparing with control (No. 1 in Table 11).

### Example 7

### Molded Compounds with CNC-PF Powder

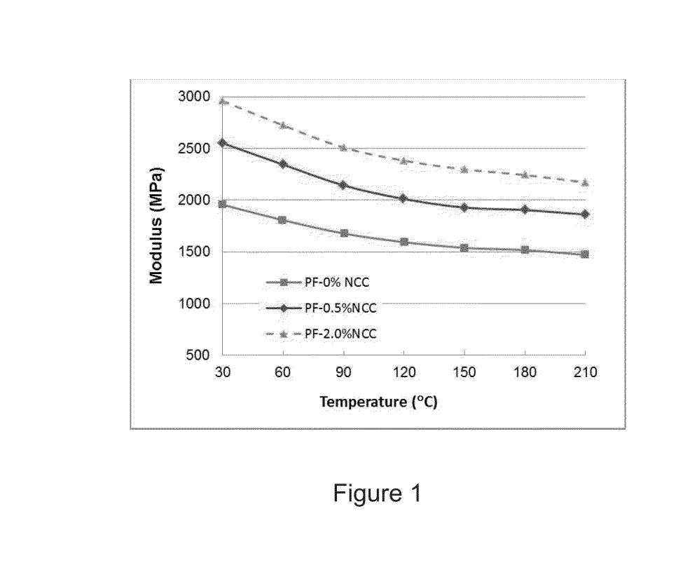

The CNC-PF powders in Table 1 coded PPF0, PPF1 and PPF3 were used. The electric press with dimension of 12 inches by 12 inches was used to make the molded products under 150° C. for 3.5 minutes with aluminum mold of 6-7 mm in width, 50 mm in length, and 1 mm in thickness. The thermo-mechanical properties were evaluated by Dynamic Mechanical Analyzer (DMA Q 800 from TA Instruments) with following conditions: in dynamic mold, frequency of 1 Hz, strain of 0.1%, and heating rate of 10° C./min from 25° C. to 250° C. The storage moduli of these materials are illustrated in FIG. 1.

From FIG. 1, it can be seen that with addition of small amount of CNC could significantly improve the storage modulus, in which 0.5% wt CNC increased the modulus by 25%-30% in different temperatures (from 30° C. to 210° C.), and 2.0% wt CNC increased the modulus by 48%-51% in different temperatures (from 30° C. to 210° C.)

CNC-pMDI Formulations

The first step of process according to invention consists of a) preparing the CNC aqueous dispersion through soaking the required amount of CNC in water for a few hours to make sure the CNC is well dispersed in water (it could become gel-like liquid if the CNC concentration reaches to ≧3-5% wt) with different methods, such as sonication, high shear mixing etc.; b) transferring pre-prepared CNC dispersion into polymeric MDI via mechanical mixing to form stable uniform CNC-pMDI emulsion system and adjusting the active component content to 40-70% wt through the addition of water if necessary.

Below we list some specific examples

### Example 8

The spray-dried NCC powder was dispersed in water at different concentrations (0.5%-1.5%) by magnetic mixing, followed by mechanical mixing and ultrasonic mixing at room temperature. The resulting NCC suspensions were characterized as follows: 1) Viscosity measured by a viscometer (Brookfield—LVT), 2) Turbidity measured with a Micro 1000 IR Turbidimeter (Scientific Inc. Company), and 3) Birefringence (a specific property of non-aggregated NCC) checked under polarized light.

CNC suspension was mixed with emulsifiable pMDI, I-Bond® MDF EM 4330 from Huntsman (here after E-MDI) with different ratio of CNC aqueous dispersion to E-MDI based on actual weight via mechanical means. The mixture of CNC-E-MDI emulsion is stable for certain period time.

An Automated Bond Evaluation System (ABES) was used to evaluate the bond strength development of NCC/E-MDI resin as a function of time at 120° C. measured by ABES. The test conditions with ABES are given as:
a. Veneer: 117×20×0.7 mm aspen
b. Bonding area: 5 mm×20 mm
c. CNC dosage in glue: 2% CNC based on E-MDI
d. Assembly time: no
e. Pressing: 120° C. for 30-90 seconds
f. Replicate: 5 at each bonding condition

TABLE 12
Properties of shear strength of AEBS made with E-MDI with/without CNC

| | | | | CNC (%)³ | | Shear strength (MPa) | |
|---|---|---|---|---|---|---|---|
| | | NVC¹ | Spread rate² | (based on | (Based on | (cured at 120° C.) | |
| No. | Code | (%) | (mg/cm²) | liquid) | solid) | 30 sec | 90 sec |
| 1 | E-MDI | 100 | 1.80-1.92 | 0 | 0 | 0.96 ± 0.18 | 1.28 ± 0.22 |
| 2 | E-MDI/water | 50 | 1.36-1.40 | 0 | 0 | 2.31 ± 0.39 | 4.44 ± 0.98 |
| 3 | E-MDI/CNC | 51 | 1.36-1.38 | 1 | 2.0 | 3.20 ± 0.46 | 5.50 ± 0.98 |

¹NVC: non volatile content. E-MDI is treated as 100% active component
²spread rate: calculated based on active components in which E-MDI treated as 100% active components
²CNC content based on mixture of E-MDI resin and CNC either in liquid basis or solid (treated E-MDI as 100% solid)

It can be seen that incorporation of CNC into E-MDI could improve the bonding strength development

### Example 9

The sodium forms of CNC, spray-dried CNC (code SD CNC), and freeze-dried CNC (code FD CNC), were dispersed in water first and then incorporated with E-MDI at loading level of 0.5-1.0% wt. based on E-MDI weight (same as example 8). The resulting adhesives (or binders) are used to manufacture strand boards. The panel manufacturing conditions are listed as follow:

### Panel Dimension: 11.1 mm by 508 mm by 584 mm

Panel construction: random orientation/three layer
Mass distribution: 25/50/25
Wood species: 70% Aspen+30% high-density hardwoods
Target mat moisture: 6.5-7.5% in face layer and 5-7% in core layers
Slack wax content: 1.0% (on a dry wood basis) in face and core layers
Resin content in face: 2.5% E-MDI with/without CNC (on a dry wood weight)
Resin content in core: 2.5% regular polymeric MDI (on a dry wood weight)
Target board density: 624±24 kg/m³ (39±0.5 lb/ft³) (oven dry basis)
Press temperature: 220° C. (platen)
Total press time: 150 seconds (daylight to daylight)

### Replicates: 2

All strand board were conditioned in a chamber at 65% RH and 20 C until they reached the equilibrium moisture contents prior test. The internal bond (IB) strength, thickness swelling (TS) and water absorption (WA) of 24 hour soaking in running water at 20° C., dry modulus of rupture (MOR) and modulus of elasticity (MOE), and wet MOR and MOE after 24 hour running water soaking according CAS O437-93 standard.

The mechanical properties of strand board made with E-MDI with/without CNC is illustrated as below:

TABLE 12
Properties of shear strength of AEBS made with E-MDI with/without CNC

| Properties | | Unit | No. 1 | No. 2 | No. 3 | No. 4 | No. 5 |
|---|---|---|---|---|---|---|---|
| Resin loading | | % | 2.50 | 2.50 | 2.50 | 2.50 | 2.50 |
| pMDI | | % | 2.50 | — | — | — | — |
| E-MDI | | % | — | 2.50 | 2.488 | 2.488 | 2.475 |
| CNC¹ | Freeze-dried | % | — | — | 0.012 | — | — |
| | Spray-dried | % | — | — | | 0.012 | 0.025 |

Mechanical Properties

| IB | | MPa | 0.50 | 0.42 | 0.47 | 0.44 | 0.52 |
|---|---|---|---|---|---|---|---|
| MOR | Dry | MPa | 40.51 | 39.50 | 34.10 | 39.00 | 31.60 |
| | Wet | MPa | 13.10 | 12.40 | 15.90 | 16.40 | 13.40 |
| | Retention | % | 32.34 | 31.39 | 46.63 | 42.05 | 42.41 |
| MOE | Dry | MPa | 5500 | 5326 | 4900 | 4988 | 4701 |
| | Wet | MPa | 2730 | 2628 | 3142 | 3152 | 2663 |
| | Retention | % | 49.64 | 49.34 | 64.12 | 63.19 | 56.65 |

| | | | | | | |
|---|---|---|---|---|---|---|
| TS | % | 18.20 | 17.70 | 17.30 | 16.50 | 14.50 |
| WA | % | 24.40 | 21.80 | 22.00 | 24.40 | 20.00 |

¹CNC content based on E-MDI content, CNC is 3% aqueous dispersion

It can be seen that addition of CNC into polymeric MDI can improve wet flexural strength (MOR) and also MOE. Addition of CNC could also reduce the thickness swelling (TS) and water absorption (WA).

### REFERENCES

Araki J., Wada M., Kuga S., and T. Okano (1998). Low properties of microcrystalline cellulose suspension prepared by acid treatment of native cellulose. Colloids Surf. A, 142: 75-82
Auad, M. L., V. S. Contos, et al. (2008). “Characterization of nanocellulose-reinforced shape memory polyurethanes.” Polymer International 57(4): 651-659
Azizi Samir M. A. S., Alloin F., and A. Dufresne (2005). A Review of recent research into cellulosic whiskers, their properties and their applications in nanocomposite field. Biomacromolecules, 6: 612-626
Bondeson D., Mathew A., and K. Oksman (2006). Optimization of the isolation of nanocrystals from microcrystalline cellulose by acid hydrolysis. Cellulose, 13:171-180
Campbell A G, Walsh A R (1985). The present status and potential of kraft lignin-phenol-formaldehyde wood adhesives. Journal of Adhesion, 18: 301-314
Cao, X., H. Dong, et al. (2007). “New nanocomposite materials reinforced with flax cellulose nanocrystals in waterborne polyurethane.” Biomacromolecules 8(3): 899-904
Chen, Guangjun; Ming Wei; Jinghua Chen; Jin Huang; Alain Dufresne and Peter R. Chang. 2008. Simultaneous reinforcing and toughening: New nanocomposites of waterborne polyurethane filled with low loading level of starch nanocrystals. Polymer 49 (2008): 1860-1870
Diddens I., Murphy B., Krisch M., and M. Muller (2008). Anisotropic elastic properties of cellulose measured using inelastic X-ray scattering. Macromolecules, 41: 9755-9759
Doering G A, Harbor G. Lignin modified phenol-formaldehyde resin. U.S. Pat. No. 5,202,403, 1993
Favier V., Canova G. R., Cavaille J. Y., Chanzy H., Dufresne A., and C. Gauthier (1995a) Nanocomposite materials from latex and cellulose whiskers. Polym. Adv. Technol., 6, 351-355
Favier, V., H. Chanzy, and J. Y. Cavaille. (1995b) Polymer nanocomposites reinforced by cellulose whiskers. Macromolecules 28:6365-6367
Gopalan Nair, K. and A. Dufresne (2003). Crab shell whisker reinforced natural rubber nanocomposites 1. Processing and wselling behaviour. Biomacromolecules, 4(3): 657-665
Grunert, M. and W. T. Winter (2002). Nanocomposites of cellulose acetate butyrate reinforced with cellulose nanocrystals. J. Polym. Environ. 10(1/2):27-30
Klasnja B, Kopitovic S. Lignin-phenol-formaldehyde resins as adhesives in the production of plywood. Holz als Roh- and Werkstoff. European Journal of Wood and Wood Products, 1992, 50: 282-285
Liu H., and M. P. G. Laborie (2010) In situ cure of cellulose whiskers reinforced thermosetting phenolic resins: Impact on resin morphology, cure and performance. Proceedings of the International Convention of Society of Wood Science and Technology and UN Economic Commissions for Europe—Timber Committee, October 11-14, Geneva, Switzerland.
Liu H., and M. P. G. Laborie (2011). Bio-based nanocomposites by in situ cure of phenolic prepolymers with cellulose whiskers. Cellulose, 18: 619-630
Morin A. and A. Dufresne (2002). Nanocomposites of chitin whiskers from Riftia tubes and poly(caprolactone). Macromolecules, 35: 2190-2199
Nakagaito A. N. and H. Yano (2004). The effect of morphological changes from pulp fiber towards nano-scale fibrillated cellulose on the mechanical properties of high-strength plant fiber based composites. Appl. Phys. A, 78, 547-552.
Nakagaito A. N. and H. Yano (2005). Novel high-strength biocomposites based on microfibrillated cellulose having nano-order unit web-like network structure. Appl. Phys. A 80, 155-159
Olivares M, Guzman J A, Natho A, Saavedra A. Kraft lignin utilization in adhesives. Wood Science and Technology, 1988, 22: 157-165
Pizzi A. Chap. 28: Natural Phenolic Adhesives II: Lignin, in Handbook of Adhesive Technology, 2^{nd} Ed.; Pizzi A. Eds., Marcel Dekker: New York, 2003
Revol, J.-F., Bradford, H., Giasson, J., Marchessault, R. H. and Gray, D. G. “Helicoidal self-ordering of cellulose microfibrils in aqueous suspension,” Int. J. Biol. Macromol. 14 (3): 170-172(1992)
Rowell R M, Pettersen R., Han J S, Rowell J S., Tshabalala M A., Chapter 3 Cell Wall Chemistry, in Handbook of Wood Chemistry and Wood Composites. 2005, CRC Press: Boca Raton
Sakurada I., and Y. I. T. Nukushina (1962). Experimental determination of the elastic modulus of crystalline regions in oriented polymers. J. Polym. Sci., 57: 651-659
Siqueira G., Bras J. and A. Dufresne (2010). Cellulosic bionanocomposites: A review of preparation, properties and applications. Polymers, 2:728-765
SRI Consulting, WP report: Phenol-Formaldehyde (PF) Resins (abstract), http://www.sriconsulting.com/WP/Public/Reports/pf_resins/accessed on Aug. 16, 2011
Wang M C, Leitch M, Xu C B. Synthesis of phenol-formaldehyde resol resins using organosolv pine lignins. European Polymer Journal, 2009, 45(12): 3380-3388
Wang, S. Q., C. Xing, Wood adhesives containing reinforced additives for structural engineering products, International Application Number WO 2009/086141 A2, 2009
Wang, Y X., H. Tian, et al. 2010. Role of starch nanocrystals and cellulose whiskers in synergistic reinforcement of waterborne polyurethane. Carbohydrate Polymers 80(3): 665-671
Wooten A L, Sellers T J, Tahir P M. Reaction of formaldehyde with lignin, Forest Products Journal, 1988, 38(6): 45-46

1. A thermoset resin system for a wood adhesive comprising:
a thermoset resin,
a cellulose nanocrystal, and
30 to 60% weight of moisture,
wherein the cellulose nanocrystal is reinforcing the phenolic thermoset resin system,
comprising a weight ratio of hydroxide to phenol from 0.03:1 to 0.3:1.

2. The system of claim 1, wherein the thermoset resin is a phenolic powder for at least one of wood or molded products.

3. (canceled)

4. A thermoset resin system comprising
a phenolic component,
a formaldehyde component, and
a cellulose nanocrystals,
comprising a weight ratio of hydroxide to phenol from 0.03:1 to 0.3:1.

5. The system of claim 4, wherein the system comprises from 4 to 6% weight of moisture per resin system.

6. The system of claim 4, wherein the system comprises from 0.5 to 4% weight of cellulose nanocrystals per resin system.

7. The system of claim 4, wherein the phenolic component is phenol.

8. The system of claim 4, wherein the phenolic component is phenol and lignin.

9. The system of claim 8, comprising a molar ratio of formaldehyde:phenol component from 1.8:1 to 3:1.

10. (canceled)

11. The system of claim 4, wherein the system comprises 35 to 55% weight of solids in the resin system, a % weight of moisture and the cellulose nanocrystals is incorporated into an intimate contact with the system, whereby the incorporation is through in-situ polymerization.

12. The system of claim 11, wherein the system comprises from 40 to 45% weight solids per resin system.

13. The system of claim 11, wherein the system comprises from 0.5 to 1% weight of cellulose nanocrystals per resin system.

14. The system of claim 11, wherein the phenolic component is phenol.

15. The system of claim 11, wherein the phenolic component is phenol and lignin.

16. The system of claim 15, comprising a molar ratio of formaldehyde:phenol component of from 1.8:1 to 3:1.

17. (canceled)

18. A method of producing a liquid resin adhesive system comprising the steps of:
providing a phenolic compound;
providing a formaldehyde compound;
providing a cellulose nanocrystals;
providing an alkaline hydroxide;
mixing the phenolic compound and the cellulose nanocrystals with water and the alkaline hydroxide at a constant temperature making a phenolic blend;
methylolation of the phenolic blend by adding the formaldehyde compound to the phenolic blend to start the polymerization through condensation and controlling the temperature producing a reaction mixture; and
stopping the polymerization by cooling the reaction mixture until the mixture reaches a specific viscosity.

19. The method of claim 18, further comprising adding more formaldehyde and/or alkaline hydroxide to the reaction mixture during the polymerizing step.

20. A method for producing a powder resin adhesive system comprising the steps of
providing a phenolic compound;
providing a formaldehyde compound;
providing a cellulose nanocrystals,
providing an alkaline hydroxide,
mixing the phenolic compound and the formaldehyde compound with water at a constant temperature making a resin mix having a specified solids weight % in the mix;
polymerizing the resin mix by adding the alkaline hydroxide to the resin mix to start the polymerization and controlling the temperature producing a reaction mixture;
monitoring and adjusting the temperature and pH of the reaction mixture;
stopping the polymerization by cooling the reaction mixture until the mixture reaches a specific viscosity and an alkaline pH to produce a phenolic resin,
mixing the cellulose nanocrystals with the phenolic resin and
drying the phenolic resin to produce the powder.

21. The method of claim 20, wherein the phenolic compound is at least one of phenol or lignin.

22. The method of claim 20, wherein the formaldehyde is a para-formaldehyde.

23. An oriented strand board or a plywood produced with the resin system defined in claim 3.

24. (canceled)

25. (canceled)

26. (canceled)

27. (canceled)

28. (canceled)

29. (canceled)

30. The system of claim 4, wherein the system comprises 2 to 8% weight of moisture per resin system.
